(19) United States
(12) Patent Application Publication
(10) Pub. No.: US 2008/0313051 A1
(43) Pub. Date: Dec. 18, 2008

(54) Online Preowned Golf Club Sales

(75) Inventor: Michael Slock, Raleigh, NC (US)

Correspondence Address: WARD AND SMITH, P.A., 1001 COLLEGE COURT, P.O. BOX 867, NEW BERN, NC, 28563-0867, US

(73) Assignee: GLOBAL VALUE COMMERCE, INC, Raleigh, NC (US)

(21) Appl. No.: 12/138,501

(22) Filed: Jun. 13, 2008

Related U.S. Application Data
(60) Provisional application No. 60/934,701, filed on Jun. 15, 2007.

(51) Int. Cl. G06Q 30/00

(52) U.S. Cl. 705/26; 705/39

(57) ABSTRACT

A portal is provided in which accounts can be created and sellers of golf clubs have login privileges. A seller of preowned used clubs can input an inventory of clubs it wishes to sell. Account representatives at the portal implement a system that grades the clubs and provides a group price. The clubs are then shipped and payment made. Thereafter, the clubs may be made available to the public in accordance with the portal owner's proprietary grading and pricing schemes.

### CROSS REFERENCE TO RELATED APPLICATIONS

This application is related to provisional application Ser. No. 60/934,701 filed Jun. 15, 2007 and entitled Online Preowned Golf Club Sales System and Method, the disclosure of which is incorporated by reference herein in its entirety. Applicant claims priority to the filing date of said provisional application Ser. No. 60/934,701.

### FIELD OF THE INVENTION

The present invention relates generally to a sales system for selling preowned golf clubs. More particularly, the invention relates to an online sales system for selling preowned golf clubs such as demonstration clubs to a central portal owner who then can resell the preowned golf clubs.

### BACKGROUND OF THE INVENTION

In the golf business there is a large market for preowned or used golf clubs, especially for certain kinds of customers who find the cost of brand new golf clubs which can be custom ordered and fit to a particular golfer's swing excessively expensive. For the average golfer, while custom fit new clubs may produce some improvement in their game, given the average player's frequency of play and skill level, such fittings may often make very little difference. Thus, it becomes desirable for such golfers to be able to buy used golf clubs, which are generally in fairly good condition.

There are primarily two sources for used clubs. A major source are demonstration clubs which are obtained through manufacturer representatives, and demonstrated at various locations such as retailers, country clubs and club rental locations. Other sources include used clubs which were bought new by another user, and replaced after a short amount of time, for example, as a trade in or credit on a purchase of new clubs at retail locations.

However, the purchase of used clubs is haphazard at best and purchasers of used clubs desire to have a centralized location providing a great variety of choices. Thus, while retailers may make demonstration clubs available for resale, selection is limited. Further, there is a disincentive for retailers to sell used clubs because sales of used clubs often cut into sales of new clubs. Moreover, in such a system, quality and grading of used clubs is haphazard and in many cases returned clubs cannot be resold for a number of reasons.

For the above reasons, what is needed is a method of selling and buying preowned golf clubs at a centralized location, which provides great selection, consistent grading quality and avoids the problems of current methods of reselling preowned golf clubs.

### SUMMARY OF THE INVENTION

In accordance with the invention there is provided a business to business portal in which accounts are created and representatives have login privileges. The functionality of the portal is such that a seller of preowned clubs can input an entire inventory of clubs it wishes to sell or return. Account representatives at the portal implement a system that grades the clubs and provides a group price. Thereafter, the clubs are made available to the public in accordance with the portal owner's proprietary grading and pricing scheme.

Transactions can occur with manufacturers directly, or with retailers or individuals. In the case of a manufacturer, a negotiated price may be set in one exemplary embodiment for a group of clubs. With respect to retailers or individuals, published prices for different grades and brands of clubs may be provided as an alternative exemplary embodiment so that the retailer knows the expected return from the sale of a preowned club to the owner of the portal.

In one aspect a computer implemented method of reselling preowned golf clubs to a central buyer who owns a portal is provided. A portal is established for a portal owner on at least one server on a network. An account is created for a seller on the portal. When preowned clubs are to be sold to the portal owner, a return shipment record is created on the portal for the seller. The preowned golf clubs are then packed and shipped to the portal owner. The preowned golf clubs are then inspected at an owner's site and a payment is determined in accordance through the predetermined criteria. Payment is then issued to the seller of the preowned golf clubs as determined with the predetermined criteria.

In one exemplary embodiment, any discrepancies are reported to the seller. A record of the price paid may be posted on the portal for inspection by the seller. In another exemplary embodiment, the preowned clubs are processed through the portal by golf company representatives and payment is made to the golf company. Alternatively, the clubs are processed through the portal by golf company representatives and payment is made to the representative directly. The seller can also be a retail merchant and payment made directly to the retail merchant.

The inspection of the shipment can also determine whether there are any missing items as compared to the return shipment record. A predetermined amount of time is allowed for the seller to account for the missing items before issuing a payment. In another specific embodiment, the predetermined criteria is defined by a negotiated contract between the portal owner and seller.

Yet still further, the invention also involves a system for conducting online sales of preowned golf clubs to a portal owner. The system includes a server on a network programmed to perform the aforementioned steps, preferably the seller's computer is connected on the network to the server.

These and other advantages and features that characterize the invention are set forth in the claims annexed hereto and forming a further part hereof. However, for a better understanding of the invention, and of the advantages and objectives obtained through its use, reference should be made to the drawings and to the accompanying descriptive matter in which there are described exemplary embodiments of the invention.

### BRIEF DESCRIPTION OF THE DRAWINGS

FIG. 1 is a general system diagram showing a network on which the invention may be implemented.

FIG. 2 is a general flow diagram illustrating the return shipment overview process for preowned golf clubs.

FIG. 3 is a general flow diagram illustrating how the method is adjusted to account for discrepancies in return shipments.

FIG. 4 is a flow diagram illustrating how the method accounts for missing products in return shipments.

### DETAILED DESCRIPTION OF THE INVENTION

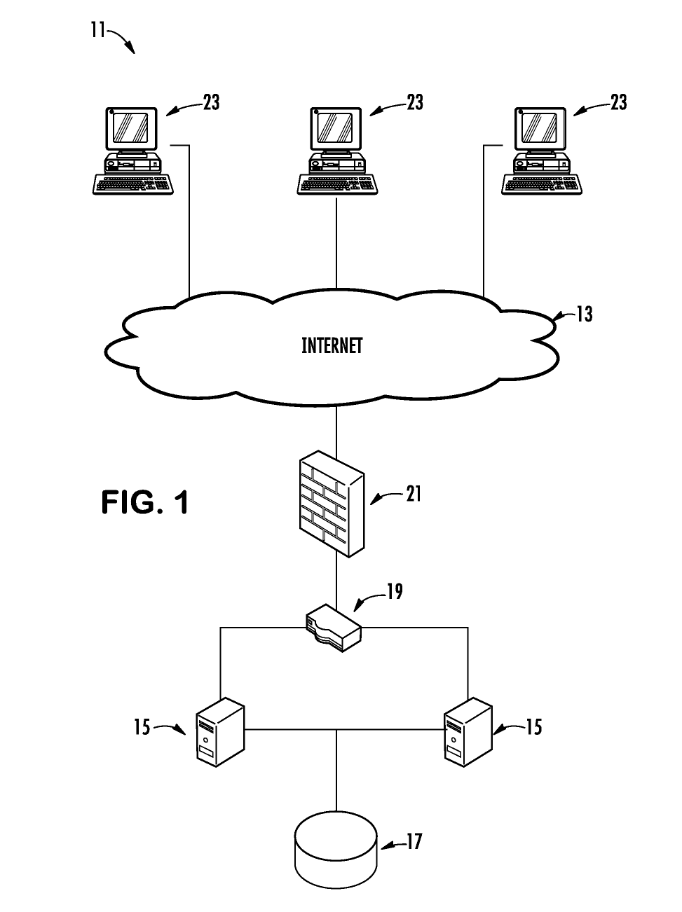

FIG. 1 illustrates a typical network 11 on which the system of the invention may be implemented. A central location including servers 15 for implementing the method of the invention is connected to a network 13 such as the internet. In order to provide controlled flow of data through the network, the servers 15 are connected through a firewall 21 behind which is located a load balancer 19 which balances communications to and from, in this embodiment, web servers 15. The web servers 15 are connected to a central database 17 to manage the processing of transactions involving returned preowned golf clubs sold to the owner of the portal. In order to implement the transactions, customers are connected through, for example, simple personal computers 23 to the network 13 in a secure manner with encryption and passwords, as will be readily apparent to those of ordinary skill in the art.

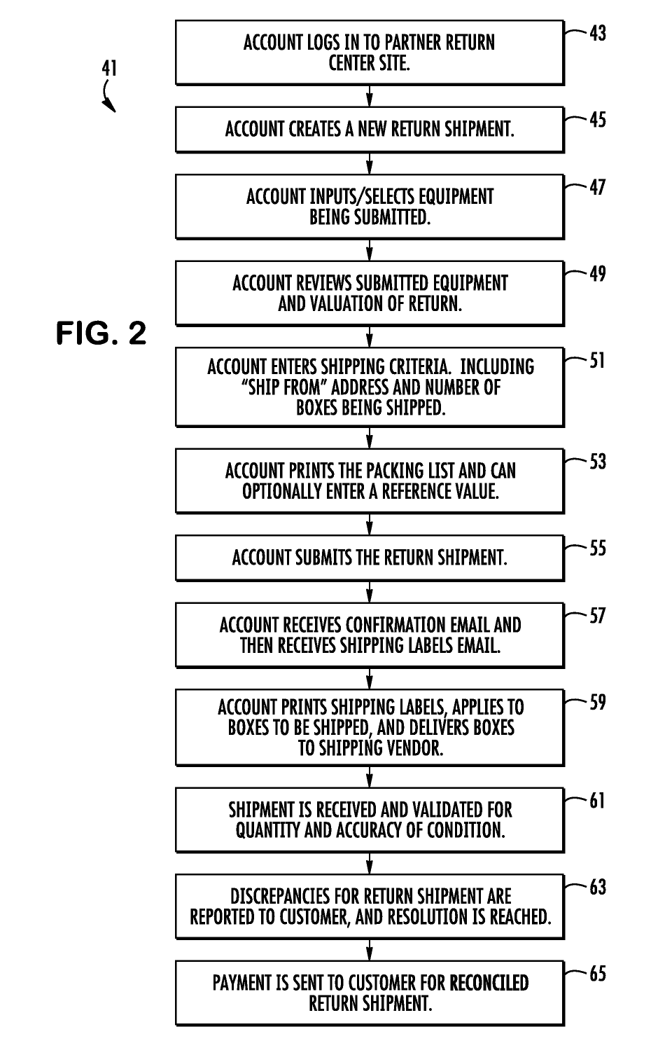

As illustrated in FIG. 2, a typical transaction flow 41 involves an initial step of logging in to the return center site 43. A party, who is a seller or customer as the terms are used interchangeably, wishing to sell golf clubs creates a return shipment order 45 through an account that was previously created or is currently being created. Information about the equipment being returned and submitted for sale is input into the portal 47.

Based on the information submitted, the portal owner returns a projected valuation 49 to the seller. The seller then enters the shipping criteria, including a “shipped from” address and number of boxes being shipped 51. A packing list is then printed for the seller, optionally including a reference value 53. The seller then submits the return shipment 55. The seller then receives a confirmation e-mail as well as labels for shipping attached to the e-mail 57.

One this is done, the seller may then print the shipping labels, and apply them to the boxes to be shipped and delivers the boxes to the shipping vendor 59.

When the shipment is received, it is validated for quantity and accuracy of conditions 61. If there are any discrepancies, they are reported to the seller and resolution is reached 63 as will be more clearly described hereafter. Once resolution is reached, payment is sent to the seller or customer for the reconciled return shipment 65.

The seller can be retail outlets, manufacturer representatives, manufacturers or individuals. In terms of payments, they can be made to any one of the parties depending on various arrangements. For example, in the case of manufacturer representatives payment can be made to the representative or the manufacturer as the case may be.

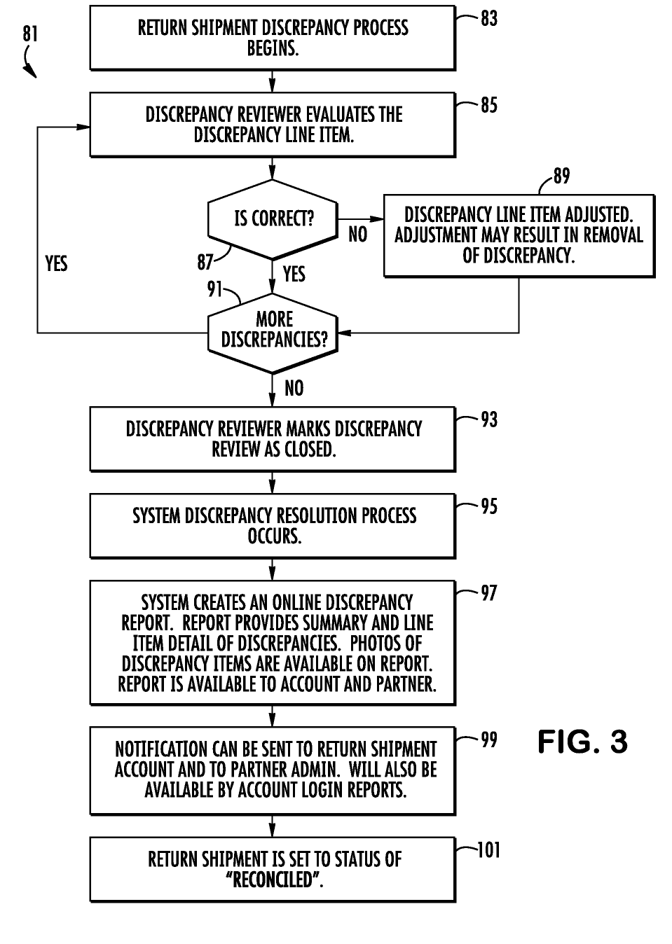

FIG. 3 illustrates in an exemplary manner how a discrepancy can be resolved 81. If there is discrepancy in the shipment based on what was reported, a discrepancy resolution process is initiated 83. A discrepancy reviewer at the portal site evaluates the discrepancy line item 85. A determination is made about whether the discrepancy is correct 87. If it is incorrect, the line item is adjusted 89, which may result in removal of the discrepancy.

If a discrepancy does exist, in either case, the process flows to the next step 91 to determine if there are more discrepancies. If there are more discrepancies, then the process returns to step 85 to further evaluate discrepancy line items. If there are no more discrepancies, then the reviewer marks the discrepancy review as closed 93. The discrepancy is resolved at step 95 in accordance with a predetermined set of criteria, or as a negotiated set of criteria between the portal owner and the seller/customer.

The system then creates an online discrepancy report which provides a summary and line item detail of the discrepancies 97. Photographs of the discrepancy items are available on the report which is made available to the seller. Notification is then sent to the return shipment account 99. The return shipment is then set to the status of “reconciled” 101 to allow for payment to be processed.

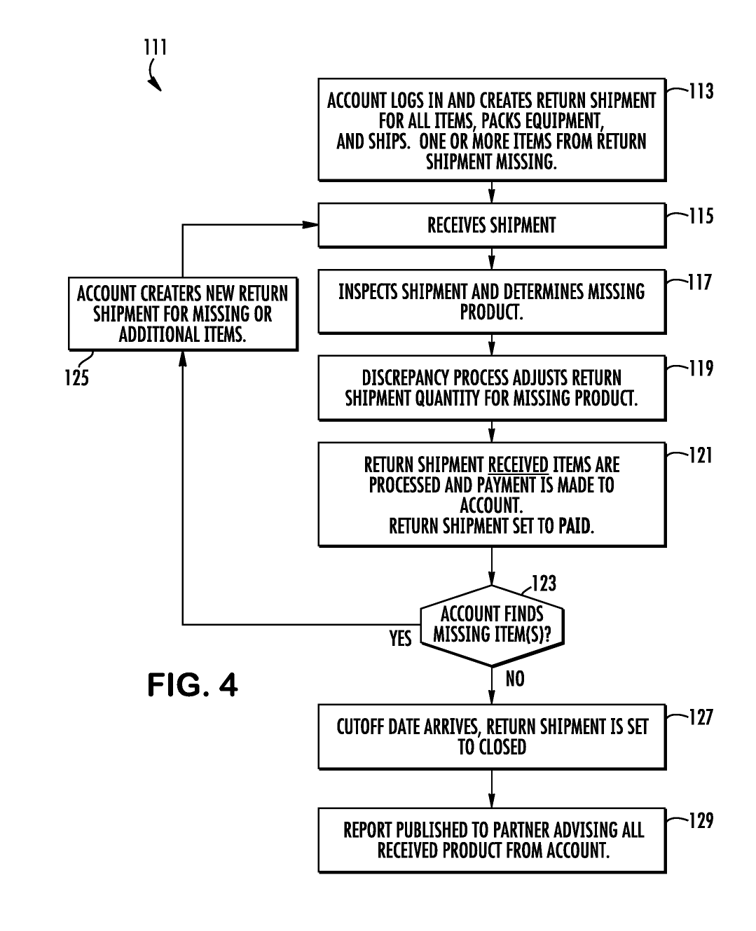

In another aspect, it is also possible that a shipment may have missing products and this is illustrated in flow diagram 111 of FIG. 4 which illustrates how a missing product situation may be reconciled. In this case, a seller may login and create a return shipment for all invoice items, but when the shipment is received, one or more items from the invoice is missing 113. When the portal owner receives the shipment 115, the shipment is inspected 117 and it is determined what products are missing. In this case the missing product process resets the invoice quantity and return shipment quantity for the missing products 119. The items that were received are processed 121 and payment is made to the seller with the return shipment set to paid 121.

It is possible that the seller later finds the missing items 123. If that occurs, the account creates a new return shipment for missing items 125 and the process returns to step 115.

If the missing items are not found, a predetermined amount of time is allowed for the missing item to be found, but when a cutoff date arrives, the portal owner sets the system invoice record to closed 127. A report is sent to the seller on the network advising of payment to the account 129.

As will be readily appreciated, once the used clubs are bought, the return golf clubs can then be resold through the portal, for example, through the same network to the general public and/or others specializing in sale of used clubs. In accordance with the centralized grading system used, prices can be set in a comparable manner for review and ordering of golf clubs, for example, through the internet from a webpage.

While the present invention has been illustrated by a description of various embodiments and while these embodiments have been described in considerable detail, it is not the intention of the applicants to restrict, or in any way limit the scope of the appended claims to such detail. The invention in its broader aspects is therefore not limited to the specific details, representative apparatus and method, and illustrative example shown and described. Accordingly, departures may be made from such details without departing from the spirit or scope of applicants' general inventive concept.

What is claimed is:

1. A computer implemented method of reselling preowned golf clubs, comprising:
for a portal owner, establishing a portal on at least one server on a network;
creating an account for at least one seller on the portal;
creating a return shipment record on the portal for the seller, and packing and shipping preowned golf clubs to the portal owner;
inspecting the preowned golf clubs at a portal owner site, and determining a payment in accordance with predetermined criteria; and
issuing a payment to the seller for the preowned golf clubs as determined with said predetermined criteria.

2. The computer implemented method of claim 1, further comprising reporting to a seller any discrepancies between preowned golf clubs received and the return shipment record.

3. The method of claim 1, further comprising posting on the portal a record of price paid for returned preowned golf clubs.

4. The method of claim 1, wherein said preowned clubs are processed through said portal by golf company representatives and payment is made to the golf company.

5. The method of claim 1, wherein said used clubs are processed through said portal by golf company representatives and payment is made to the representative.

6. The method of claim 1, wherein said seller is a retail merchant, and payment is made to the retail merchant.

7. The method of claim 2, wherein further comprising inspecting the shipment of golf clubs to determine if there are any missing items as compared to a return shipment record, reporting through the network that there are missing items to the seller, and allowing a predetermined amount of time for the seller to account for the missing items before issuing a payment.

8. The method of claim 7, further comprising publishing a report which the seller can access through the network, and initiating said payment.

9. The method of claim 1, further comprising publishing a report which the seller can access through the network, and initiating said payment.

10. The method of claim 1, wherein said predetermined criteria is defined by a negotiated contract between the portal owner and seller.

11. A system for conducting online sales of preowned golf clubs, comprising: a server on a network, said server programmed for providing a portal for sellers of preowned golf clubs; program code for allowing a seller of preowned clubs to create an account through communication on the network; program code for allowing a seller to enter information concerning preowned golf clubs to be sold and issuing a report of price to be paid after inspection of a preowned golf club shipment; and program code for processing and issuing a payment to a seller.
